(19) United States
(12) Patent Application Publication
(10) Pub. No.: US 2026/0146730 A1
(43) Pub. Date: May 28, 2026

(54) FORK LIGHT FOR WHEELED DEVICE

(71) Applicant: BRIGHTZ, LTD., Ottawa Lake, MI (US)

(72) Inventor: James MCALLISTER, Perrysburg, OH (US)

(21) Appl. No.: 19/400,345

(22) Filed: Nov. 25, 2025

Related U.S. Application Data
(60) Provisional application No. 63/724,706, filed on Nov. 25, 2024.

(51) Int. Cl. F21V 21/08; B62J 6/26; F21V 15/01; F21W 107/13; F21Y 115/10

(52) U.S. Cl. CPC F21V 21/0816; B62J 6/26; F21V 15/01; F21W 2107/13; F21Y 2115/10

(57) ABSTRACT

Disclosed is a flexible illuminating strip including a light strip having a plurality of light emitting diodes and an elastic harness at least partially encasing the light strip while leaving the light emitting diodes exposed.

### CROSS-REFERENCE TO RELATED APPLICATIONS

This application claims priority to and the benefit of U.S. Provisional Patent Application No. 63/724,706 , filed on Nov. 25, 2024, the disclosure of which is incorporated in its entirety.

### BACKGROUND

Illumination systems, such as those using traditional light strips and power packs, are known in the art.

However, these traditional systems are often inflexible and not suited for extended and reliable use in variable conditions. Many of the existing illumination systems include rigid structures and large power sources, resulting in unappealing aesthetics and cumbersome and obtrusive attachment.

Moreover, the inflexibility of these devices makes them unsuitable for variable outdoor conditions, such as when used with wheeled articles, like bicycles, scooters, and skateboards. In these applications, variability of terrain, weather conditions, type of use, etc., can promote poor attachment and potential detachment during use, thereby reducing visibility and increasing inefficiencies.

Thus, there is a need in the art for an illumination device that overcomes the drawbacks of the prior art suitable for use with various types of articles.

### SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a flexible illuminating strip includes a light strip having a plurality of light emitting diodes and an elastic harness at least partially encasing the light strip while leaving the light emitting diodes exposed. In a further embodiment, the elastic harness encases at least a bottom side of the light strip. In another further embodiment, the light strip is a surface mount device (SMD) LED light strip. In another further embodiment, the elastic harness extends across a top of the light strip interposing each of the light emitting diodes. In another further embodiment, the light strip is a chip-on-board (COB) LED light strip. In another further embodiment, the light strip further includes a diffusing cover over the light emitting diodes, wherein the elastic harness extends at least to the diffusing cover. In another further embodiment, the light emitting diodes are not covered by a diffusing cover. In another further embodiment, the elastic harness is opaque to obscure portions of the light strip.

According to another embodiment consistent with the present disclosure, a self-securing light system includes a power source and a flexible illuminating strip electrically connected to the power source, the flexible illuminating strip including a light strip having a plurality of illumination sources disposed along a length of the light strip, and an elastic harness at least partially encasing the light strip, wherein the flexible illuminating strip is operable to be stretched about an article and secured to itself to attach to the article. In a further embodiment, the plurality of illumination sources are light emitting diodes. In another further embodiment, the light strip includes a substrate extending along the length of the light strip, wherein the substrate extends laterally from the plurality of illumination sources to define a first edge and a second edge, and wherein the elastic harness encases the first edge and the second edge of the substrate. In another further embodiment, the light strip is a chip-on-board (COB) LED strip. In another further embodiment, the light strip is a surface mount device (SMD) strip. In another further embodiment, the elastic harness provides a weather-resistant barrier around the plurality of illumination sources. In another further embodiment, the elastic harness is silicone. In another further embodiment, the substrate includes a bottom surface, and wherein the elastic harness encases the bottom surface. In another further embodiment, the device further includes a conductive wire electrically coupling the power source to the light strip, wherein the conductive wire includes a first end and a second end, wherein the first end is received by one or more terminals of the battery and wherein the second end is received by a terminal of the harness.

According to a further embodiment consistent with the present disclosure, a flexible illuminating strip is produced by curing an elastic harness at least partially around a light strip having a plurality of light emitting diodes, while leaving the light emitting diodes exposed. In a further embodiment, the light strip is potted within the elastic harness. In another further embodiment, the elastic harness is injection molded about the light strip.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE FIGURES

FIG. 1 illustrates a schematic view of a lighting system attachable to an example article, according to one or more embodiments.

FIG. 2 illustrates a top view of an example lighting system, according to one or more embodiments.

FIG. 3 illustrates a top view of an example power source, according to one or more embodiments.

FIG. 4 illustrates an exploded view of an example illuminating strip, according to one or more embodiments.

FIG. 5A illustrates the illuminating strip of FIG. 4 in an “ON” mode.

FIG. 5B illustrates the illuminating strip of FIG. 4 in an “OFF” mode.

FIG. 6 illustrates another example of an illuminating strip, according to one or more embodiments.

FIG. 7 illustrates example attachment of the lighting system to the fork of a bicycle, according to one or more embodiments.

### DETAILED DESCRIPTION OF THE FIGURES

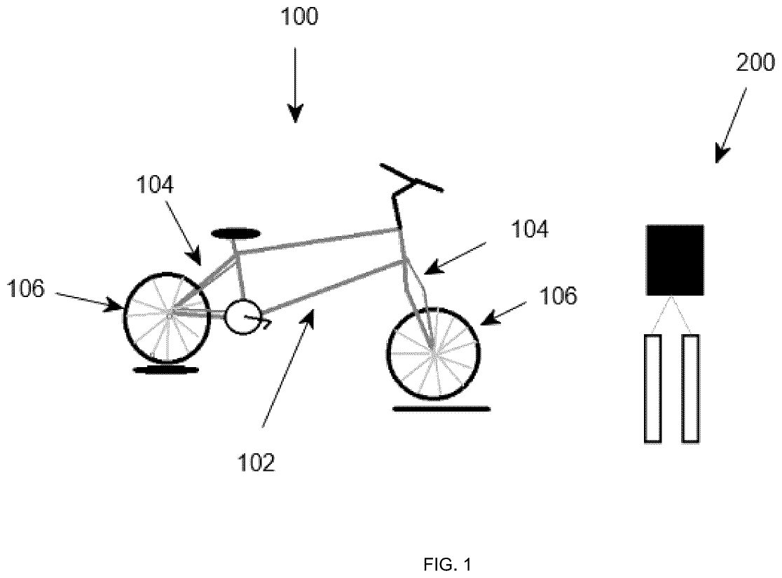

Referring generally to FIGS. 1-7, embodiments of a lighting system are disclosed. The lighting system may be a self-securing system attachable to an article. According to embodiments disclosed herein, the lighting system may flexibly attach to the article at one or more discrete portions of the article to provide illumination across a variety of different shapes and sizes.

FIG. 1 schematically illustrates an article 100 and a lighting system 200 securable thereto. In the illustrated embodiment, the article 100 is a bicycle having a frame 102, a fork 104, and wheels 106 secured to the fork 104. The article 100 may be other wheeled articles such as scooters, motorcycles, skateboards, wagons, wheelbarrows, strollers, or desk chairs. In such embodiments, the lighting system 200 may be referred to as a “fork light system” capable of securing to a forking portion of the article's frame. The lighting system may include two or more illuminating strips in various applications.

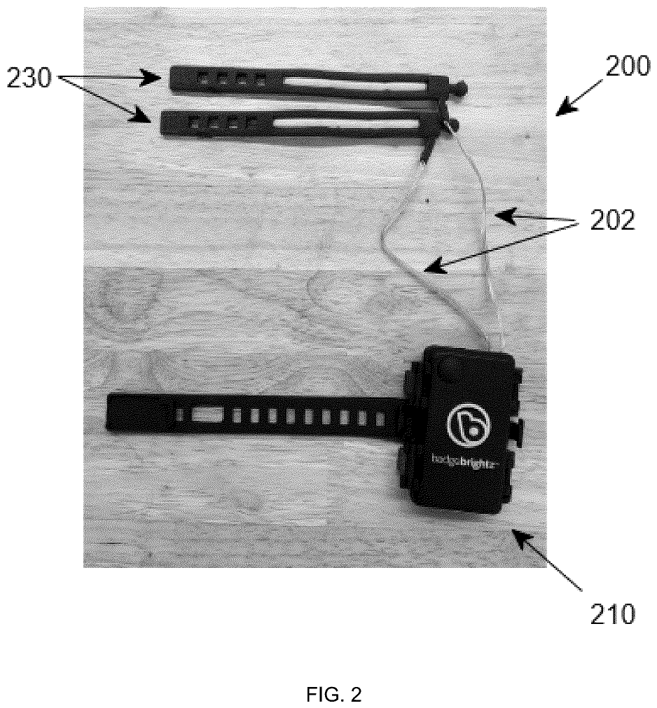

FIG. 2 illustrates a top view of the lighting system 200. The lighting system 200 includes a power source 210 and one or more flexible illuminating strips 230 electrically coupled to the power source 210. In some embodiments, the illuminating strips 230 may be coupled to the power source 210 by one or more conductive wires 202, each having a first end electrically coupled to the power source 210 and a second end electrically coupled to the one or more illuminating strips 230.

As illustrated, the power source 210 is installable at a first portion of the article 100 and the flexible illuminating strips 230 are installable at a second portion of the article 100, such as at the fork 104 of a bicycle frame 102. In such embodiments, the system may provides symmetrical lighting on both sides of the bicycle and may alternatively be referred to as a fork light or fork light system.

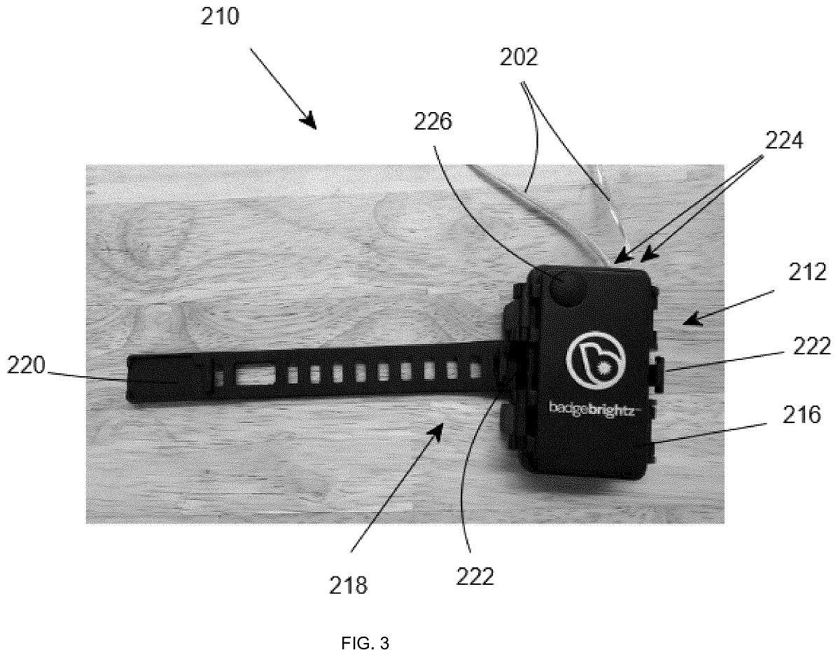

FIG. 3 illustrates a top view of the power source 210. The power source 210 includes a battery pack 212 configured to store and supply electrical energy to the lighting system 200. The battery pack 212 includes a battery (not shown) and a housing 216 configured to receive and contain the battery. The housing 216 contains electrical components operable to supply power from the battery pack 212 to the lighting system 200. The housing 216 further provides structural protection for the battery and internal electrical components while facilitating user interaction with the lighting system 200.

The housing 216 may include terminals 224 configured to establish electrical connections with external components of the lighting system 200. The terminals 224 serve as connection points for the conductive wires 202 that carry electrical power from the power source 210 to the flexible illuminating strips 230. Additionally, the housing 216 may include a button 226 for controlling operation of the lighting system 200, allowing a user to activate, deactivate, or adjust operational modes of the system 200.

The power source 210 may be programmed to control various operational modes of the lighting system 200, including a slow flash setting and a fast flash setting. In some embodiments, the fast flash setting may include three quick flashes, which may be beneficial in certain conditions, such as riding a bike at night to enhance visibility and safety. In some embodiments, each of the one or more illuminating strips 230 may be operated to flash in unison or flash in alternating patterns. In more embodiments, one of the illuminating strips 230 may be configured to flash while another of the illuminating strips provides constant illumination. Other lighting modes and configurations are contemplated without departing from the scope of this disclosure, including fade modes where the illumination gradually increases and decreases in intensity, strobe modes with rapid intermittent flashing, breathing modes with rhythmic pulsing patterns, color-changing modes for multi-color LED configurations, and dimming modes that allow users to adjust brightness levels to suit different environmental conditions or user preferences.

The power source 210 further includes a mounting device 218 configured to secure the battery pack 212 to the article 100. The mounting device 218 is operatively connected to the housing 216 and provides the mechanical interface between the power source 210 and the mounting surface of the article 100. In the illustrated embodiment, the mounting device 218 includes an elastic attachment band 220 providing a plurality of attachment slots. The attachment band 220 is configured to wrap around a portion of the article 100, such as the frame 102. The mounting device 218 further provides hooks 222 configured to engage with any one of the attachment slots of the band, allowing for adjustable tensioning of the attachment band 220 around the mounting surface. This adjustable configuration enables the power source 210 to be securely mounted to different articles 100 having varying dimensional characteristics.

In other embodiments, the power source 210 may be installed using alternative attachment methods, including zip ties, adhesives, wire clips, or other securing devices as desired for different applications or mounting surfaces. Systems and methods herein are designed for tool-free installation, allowing attachment and detachment without the use of specialized hardware or tools.

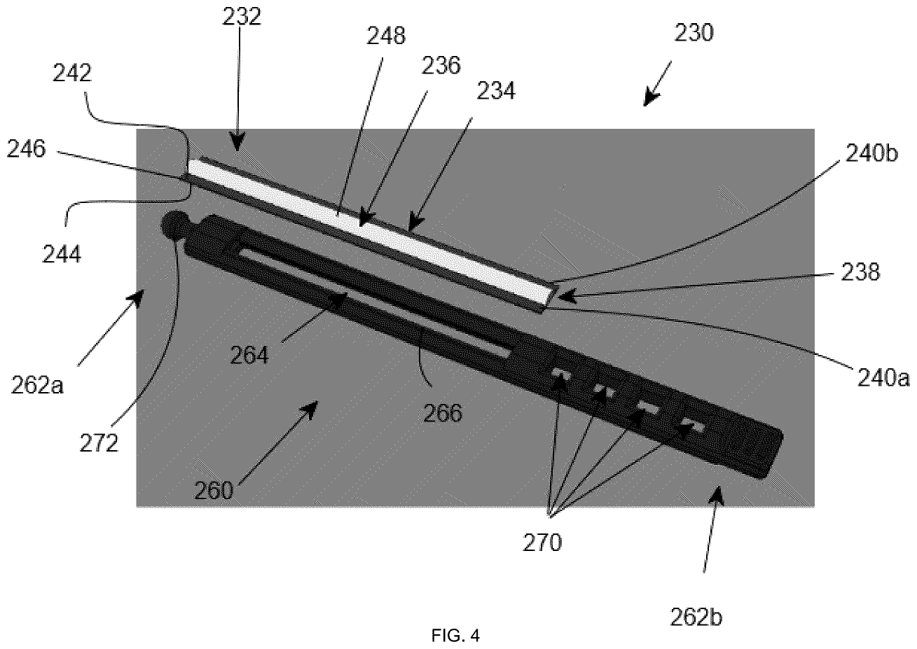

FIG. 4 illustrates an exploded view of one of the flexible illuminating strips 230. Each flexible illuminating strip 230 includes a light strip 232 and an elastic harness 260 for at least partially encasing the light strip 232. The light strip 232 includes a substrate 234 and a plurality of illumination sources 236 positioned along a length of the substrate 234. In some embodiments, the illumination sources 236 are light emitting diodes (LEDs).

With continued reference to FIG. 4, the light strip 232 includes a length 238 along which the plurality of illumination sources 236 are disposed. The substrate 234 includes a first edge 240a and a second edge 240b extending laterally from each side of the length 238 such that the plurality of illumination sources are defined on a top surface 242 between the first and second edges 240a,b. The light strip 232 further includes a bottom surface 244 and a periphery 246 extending between the top and bottom surfaces 242, 244. The harness 260 may be configured to encase one or more of the bottom surface 244, the periphery 246, and the first and second edges 240a,b to thereby hide the substrate 234 and expose the length 238 providing the plurality of illumination sources 236. The term “encase” as used herein refers to the harness 260 surrounding, covering, encapsulating, or otherwise enclosing portions of the light strip 232 to provide structural support and protection.

The plurality of illumination sources 236 may be electrically coupled together via a conductive wire or trace (not shown) extending along the substrate 234. The conductive wire provides electrical connectivity between the illumination sources 236 and enables power distribution from the power source 210 to each illumination source 236 along the light strip 232. The light strip 232 may further include a diffusing cover 248 provided over at least a portion of the top surface 242 to protect the plurality of illumination sources 236 and diffuse light emitted from the plurality of illumination sources 236.

In some embodiments, the light strip 232 may be a chip-on-board (COB) LED strip. A COB LED strip comprises a central lamp portion having LEDs extending along the length 238 of the strip, and the substrate 234 to which the central portion is adhered. The width of the substrate 234 may be greater than the width of the central lamp portion, such that the sides of the substrate 234 extend past the lamp portion. The substrate 234 may be made of copper, in whole or in part, to provide electrical conductivity to the LEDs of the lamp portion.

In another embodiment, the light strip 232 may be a surface-mounted device (SMD) LED strip. SMD light strips typically have transparent or translucent coverings for diffusing the emitted light and blending the emitted light of the numerous diodes together. In embodiments using SMD light strips, the harness 260 may provide material interposing each diode package. Each diode package has a boundary shaped to the size of the diode package, through which it can emit light. The silicone material of the harness 260 may be opaque to hide the non-illuminating portions of the light strip 232, including, for example, portions between each diode package, or may be transparent or translucent as desired.

The harness 260 is configured to encase the light strip 232 and secure it to the desired part of the article 100. The light strip 232 is secured within the harness 260 such that, as the harness 260 is stretched, the light strip 232 remains fixedly attached within the harness 260. By improving the flexibility of the illuminating strips 230, the lighting system 200 provides secure attachment and illumination in multiple directions, thereby increasing visibility and enhancing safety for users such as bicycle riders.

Still referring to FIG. 4, the harness 260 extends between first and second ends 262a, 262b that define the overall length of the harness 260. Between the first and second ends 262a,b the harness 260 defines a cavity 264 configured to receive and securely retain the light strip 232 along its length 238. The harness 260 defines an opening 266 into the cavity 264, through which the light strip 232 is configured to emit light. In embodiments, the opening 266 may be sized and shaped to correspond to that of the diffusing cover 248, such that the opening 266 forms a window around the diffusing cover 248, thereby providing protection of the substrate 234 and plurality of illumination sources 236.

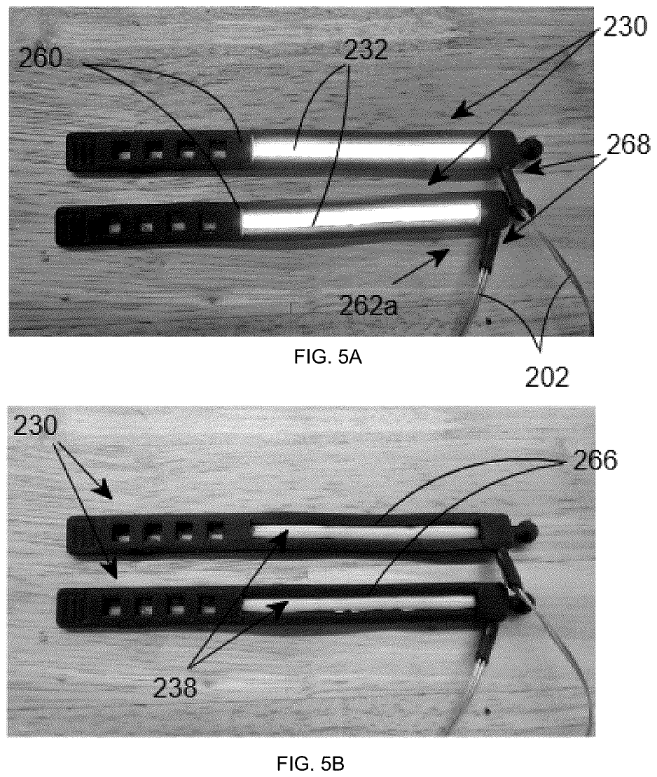

With reference to FIG. 5A, the first end 262a of each harness 260 includes an electrical terminal 268 to establish electrical connection with the one or more conductive wires 202 extending between the power source 210 and illuminating strip 230. In the illustrated embodiment, each terminal 268 extends from the first end of the harness 260 and defines an opening for receiving the one or more conductive wires 202, thereby providing a pathway for the conductive wire 202 to supply electrical power to the light strip 232 (e.g., the conductive wire extending along the substrate 234).

Referring again to FIG. 4, at the second end 262b, the harness 260 further includes an elastic band defining a plurality of slots 270, each providing attachment points for securing a tab 272 at the first end 262a to the second end 262b and thereby allowing the harness 260 to flex (e.g., wrap) around and secure to varying shapes and sizes of portions of the article 100. The elastic band may permit each of the slots 270 to deform and accommodate the tab 272 while maintaining secure engagement. In this manner, the flexible illuminating strip may be secured to itself to attach to the article.

The harness may be made of an elastic material (e.g., silicone) to provide sufficient flexibility to conform to various shapes of mounting surfaces, such as the fork 104 of the article 100. In addition, elastic materials such as silicone may be used to provide mechanical grip and traction with metal objects, reducing slippage and allowing the flexible illuminating strip 230 to remain positioned at the desired location of the article 100. The elastic nature of the harness 260 enables it to stretch during installation while maintaining secure attachment to both the light strip 232 and the article 100. Additionally, the harness 260 may provide a weather-resistant barrier to protect the electrical elements of the light strip 232. The encasing of the light strip 232 within the harness 260 may provide protection from corrosion of the electrical components, extending the operational life of the lighting system 200.

Moreover, the illuminating strip 230 may be manufactured using various processes to encase the light strip 232 in the harness 260 while leaving the plurality of illumination sources 236 exposed. In one embodiment, the light strip 232 may be encased in the harness 260 using the process of potting. Potting involves placing the light strip 232 within a low-viscosity (e.g. uncured or partially cured) liquid compound, resin, or polymer, such as epoxy, rubber, polyurethane, or silicone. In its uncured state, silicone, for example, exhibits liquid-like characteristics, allowing it to flow around the periphery 246 and top and/or bottom surfaces 242, 244 leaving the opening 266 unobstructed. The silicone is then cured to solidify its shape, thereby retaining the light strip 232 within the harness 260. In some examples, the silicone may have a depth of between 1.0 mm and 3.0 mm. Alternative manufacturing methods include injection molding and over molding processes, where a polymer or other material is formed around the light strip 232 through controlled molding techniques. In each case, the cured material adheres to the light strip 232, partially encasing and securing the light strip 232 within the harness 260.

Referring now to FIGS. 5A and 5B, the one or more illuminating strips 230 are illustrated in various lighting modes. In particular, FIG. 5A illustrates the illuminating strips 230 in an “ON” mode, whereby each of the illuminating strips 230 provide constant illumination. FIG. 5B illustrates the illuminating strips 230 in an “OFF” mode, whereby both of the illuminating strips 230 are deactivated. As explained above, the illuminating strips 230 may operate in a variety of other modes, as controlled by the power source 210, such as a fast flash or slow flash mode.

As illustrated, the encasement of the light strip 232 provides aesthetic improvements by covering unattractive substrate surfaces, thereby presenting a more visually appealing lighting appearance. The harness 260 conceals the non-illuminating portions of the light strip 232, such as the edges 240a,b and bottom surface 244 of the substrate 234, while allowing the illuminated portions (e.g., the length 238) to remain visible through the opening 266. This encapsulation creates a clean, continuous band of seemingly uninterrupted light that enhances the overall visual appeal of the lighting system 200 when installed on the article 100.

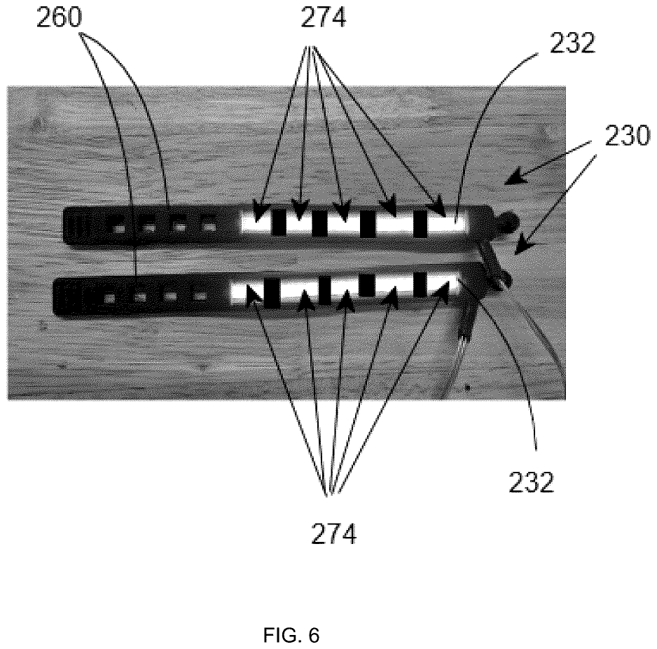

FIG. 6 illustrates an alternative embodiment of the flexible illuminating strip 230 wherein portions of the harness 260 extend over portions of the top surface 242 and the plurality of illumination sources 236 to define a plurality of illumination windows 274. This configuration is particularly suitable for use with SMD light strips, where the illumination windows 274 frame individual diode packages. In this embodiment, each illumination window 274 is shaped to the size of the diode package, through which it can emit light. The harness material interposes each diode package by extending overtop the light strip 232 and thereby concealing the substrate 234 beneath to present a more visually appealing lighting appearance. The harness 260 material may be opaque to hide the non-illuminating portions, or may be transparent or translucent as desired for different visual effects. An observer may view the light emitting from each diode package through the illumination windows 274 windows in the harness 260 without interference from additional coverings, creating a clean, segmented illumination pattern that enhances the overall visual appeal of the lighting system 200.

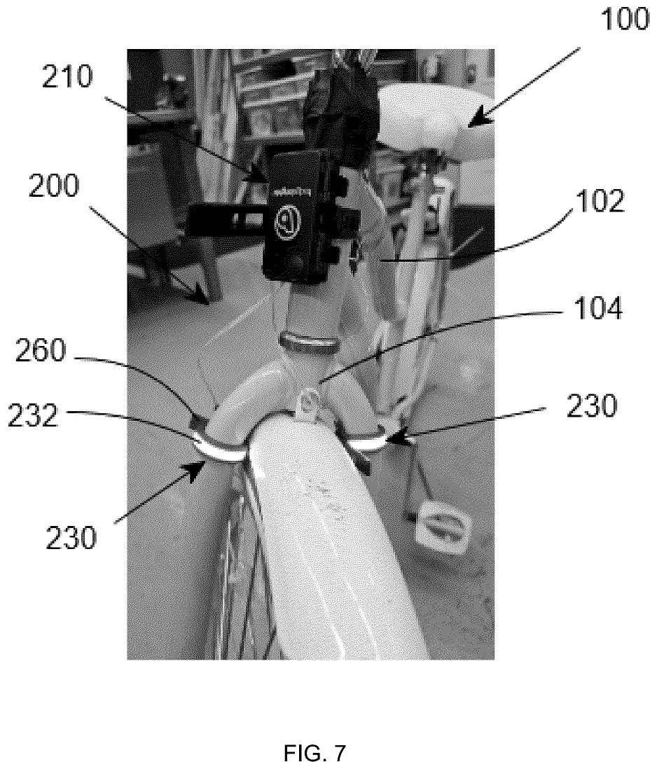

FIG. 7 illustrates the lighting system 200 secured to the article 100. As shown, the power source 210 is secured to an upper portion of the bicycle frame 102, while the one or more flexible illuminating strips 230 are secured to the bicycle fork 104. The illuminating strips 230 are positioned both vertically and horizontally offset from the upper portion of the frame 102, demonstrating the system's ability to provide distributed and symmetrical lighting coverage across different portions of the article 100. The light strip 232 further remains sufficiently flexible to flex or wrap with the harness 260 without bulging, slipping, loosening, or dislodging from its secured position within the harness 260, illustrating the secure encasement achieved through the manufacturing processes described herein. In some embodiments, the flexible illuminating strip 230 may wrap a continuous 360 degrees around a portion of the article 100, such as the fork 104, to provide illumination in every angular direction, thereby maximizing visibility and safety benefits for the user.

While this invention has been shown and described with respect to a detailed embodiment or embodiments thereof, it will be understood by those skilled in the art that changes in form and detail thereof may be made without departing from the scope of the claims of the invention.

What is claimed is:

1. A flexible illuminating strip comprising:
a light strip having a plurality of light emitting diodes; and
an elastic harness at least partially encasing the light strip while leaving the light emitting diodes exposed.

2. The flexible illuminating strip of claim 1, wherein the elastic harness encases at least a bottom side of the light strip.

3. The flexible illuminating strip of claim 1, wherein the light strip is a surface mount device (SMD) LED light strip.

4. The flexible illuminating strip of claim 1, wherein the elastic harness extends across a top of the light strip interposing each of the light emitting diodes.

5. The flexible illuminating strip of claim 1, wherein the light strip is a chip-on-board (COB) LED light strip.

6. The flexible illuminating strip of claim 5, the light strip further including a diffusing cover over the light emitting diodes, wherein the elastic harness extends at least to the diffusing cover.

7. The flexible illuminating strip of claim 1, wherein the light emitting diodes are not covered by a diffusing cover.

8. The flexible illuminating strip of claim 1, wherein the elastic harness is opaque to obscure portions of the light strip.

9. A self-securing light system comprising:
a power source; and
a flexible illuminating strip electrically connected to the power source, the flexible illuminating strip including a light strip having a plurality of illumination sources disposed along a length of the light strip, and an elastic harness at least partially encasing the light strip;
wherein the flexible illuminating strip is operable to be stretched about an article and secured to itself to attach to the article.

10. The system of claim 9, wherein the plurality of illumination sources are light emitting diodes.

11. The system of claim 9, wherein the light strip includes a substrate extending along the length of the light strip, wherein the substrate extends laterally from the plurality of illumination sources to define a first edge and a second edge, and wherein the elastic harness encases the first edge and the second edge of the substrate.

12. The system of claim 11, wherein the light strip is a chip-on-board (COB) LED strip.

13. The system of claim 12, wherein the light strip is a surface mount device (SMD) strip.

14. The system of claim 9, wherein the elastic harness provides a weather-resistant barrier around the plurality of illumination sources.

15. The system of claim 9, wherein the elastic harness is silicone.

16. The system of claim 9, wherein the substrate comprises a bottom surface, and wherein the elastic harness encases the bottom surface.

17. The system of claim 9, wherein the device further comprises a conductive wire electrically coupling the power source to the light strip, wherein the conductive wire comprises a first end and a second end, wherein the first end is received by one or more terminals of the battery and wherein the second end is received by a terminal of the harness.

18. A flexible illuminating strip produced by curing an elastic harness at least partially around a light strip having a plurality of light emitting diodes, while leaving the light emitting diodes exposed.

19. The flexible illuminating strip of claim 18, wherein the light strip is potted within the elastic harness.

20. The flexible illuminating strip of claim 18, wherein the elastic harness is injection molded about the light strip.
